(19) United States
(12) Patent Application Publication
(10) Pub. No.: US 2006/0106544 A1
(43) Pub. Date: May 18, 2006

(54) Method and system for predicting functions of compound

(76) Inventors: Yoshihiro Ohta, Tokyo (JP); Yoshiki Niwa, Hatoyama (JP); Toru Hisamitsu, Oi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/072,311

(22) Filed: Mar. 7, 2005

(30) Foreign Application Priority Data
Nov. 17, 2004 (JP) 2004-332650

(51) Int. Cl. G06F 19/00

(52) U.S. Cl. 702/19; 702/20

(57) ABSTRACT

Feature of a compound is predicted by using information on interactions between substances. A database of interactions between compounds and genes/proteins is constructed on the base of information collected from bibliographic databases, gene/protein databases, and disease databases, and an interaction network is prepared by mapping the collected information to thereby enable prediction of the features of a compound.

### CLAIM OF PRIORITY

The present application claims priority from Japanese application JP 2004-332650 filed on Nov. 17, 2004, the content of which is hereby incorporated by reference into this application.

### FIELD OF THE INVENTION

This invention relates to a method and a system which are capable of predicting pharmaceutical action and other functions of a compound by using text mining technology.

### BACKGROUND OF THE INVENTION

Genomic drug discovery researches have been conducted by the processes of identification of the individual gene by genomic research, elucidation of the functions of the individual gene, search and identification of the protein which can be used in drug discovery target, discovery of the lead compound and optimization of its structure, investigation of safety and pharmacokinetics, investigation of pharmaceutical genomics, and clinical trials, and the researchers are obliged to deal with an overwhelming amount of information from the initial stage of genomic research. According to the publication by the teams of Human Genome Project, the number of human genes are as high as thirty to forty thousands, and this means that an enormous number of experiments are required to determine adequacy of a compound as a drug discovery target, and an enormous amount of time and money are required for such massive number of experiments.

Recently, attempts have been made to carry out a vast number of different experiments at once by means of protein identification using a DNA microarray, a DNA chip, a mass spectrometer, or a robot. However, these processes produce thousands to tens of thousands of experimental data, and organization of such a large amount of data to find an adequate result has been quite difficult, and narrowing of candidates tended to be difficult. As a process using calculators, docking simulation has gained the spotlight, and in this process, possible interaction between the compound and the target protein is evaluated by computational simulation at the molecular level. This process, however, still suffers from limitation in the precision and calculation time. In addition, this process suffers from the drawback that it is incapable of acquiring information on the direct or indirect relation between the compound and the protein other than the target protein, that might be hidden by the interaction between the compound and the target protein. See Japanese Patent Application Laid-Open No. 2003-44481 and Yakugaku Zasshi, 124(9), 613-619 (2004).

### SUMMARY OF THE INVENTION

Interactions between proteins and genes as well as functions of single protein and gene have been investigated for numerous proteins and genes by the researchers of many countries, and the results have been published in articles and incorporated in databases. However, it is virtually impossible for a group of several researchers to exhaustively keep track of the vast amount of such information and organize the information as a biological network. Accordingly, drug discovery and other researches have been carried out through intuition of the researcher in charge of the particular project, and researches based on the exhaustive biological network have been extremely difficult to carry out.

In view of such situation, an object of the present invention is to provide a system which is capable of not only building a virtual biological network to conduct searches of the function of the compound but which is also capable of choosing the proteins and the genes that might be affected by the compound.

The system for predicting function of a compound according to the present invention comprises an input means for entering the subject to be searched; a list of interactions including information on pairs of gene/protein and compound that are involved in the interaction and significance of the interaction; a list of features including a plurality of items relating to each disease; a section for building an interaction network on the bases of the information of the interaction list, the interaction network comprising nodes of the compounds, the genes, and the proteins and edges of the interactions; an index including information on significance of each item in the feature list for each of the gene or protein; a section for preparing a list of features predicted for the compound by determining a predictive value for each item of the feature list for each compound by using the distance between the compound and the node in the network, the information on the significance of the interaction borne by the edge, and the index corresponding to the node; a list of features predicted for the compound prepared by the section for preparing the list of features predicted for the compound; a section for search and processing which performs the search of items having a high predictive value from the list of features predicted for the compound for the search subject entered by the input means; and a display section for displaying the search result. The interaction list and the index are prepared on the bases of the information automatically collected bibliographic database, gene database, protein database, interaction database, and other databases that are open to the public.

In this system, when the name of the compound is entered in the input section, the system refers to the list of features predicted for the compound, and the display section displays the items in the feature list, namely, the predictive information on the disease for the compound of interest together with the predictive value in the descending order of the predictive value. The display section also displays the interaction network relating to the compound entered. In addition, when an item in the feature list, namely, the name of the disease is entered in the input section, the display section displays names of the compounds in the descending order of the predictive value.

The present invention enables prediction of the effects and side effects of the compound at an early stage of the investigation, and this will improve efficiency of the subsequent investigation resulting in the shortened development period and reduced cost.

### BRIEF DESCRIPTION OF THE DRAWINGS

FIG. 1 is a schematic view of the interaction list.

FIG. 2 is a schematic view illustrating the building of a network from the interaction list by mapping.

FIGS. 3A to 3C are schematic views of preparing an index.

FIG. 4 is a schematic view of correlating the mapping with the index.

FIG. 5 shows conversion of the index to feature vector.

FIG. 6 illustrates an example of calculating the weight value of the gene/protein for the compound.

FIG. 7 illustrates an example of calculating the score vector.

FIG. 8 shows conversion of the score vector to the list of predicted features of the compound.

FIG. 9 shows marked representation of the gene and the protein which may be the relevant substance.

FIG. 10 shows list of highly relevant compounds for the disease.

FIGS. 11A and 11B show an example of the display of the feature list including the new features introduced by the updating of the network.

FIG. 12 is a schematic view showing the constitution of the system for predicting functions of the compound according to the present invention.

FIG. 13 is a schematic view showing the flow of the system for predicting functions of the compound according to the present invention.

### DETAILED DESCRIPTION OF THE INVENTION

In the present invention, function of a new drug candidate which serves the target in the drug discovery is predicted by using network of protein and compound interactions. The network of protein and compound interactions used is the one prepared by automatic extraction from technical documents in the field of medicine and biology, and the network information is supplemented by extracting information on disease information and functions of various proteins from protein database, disease database, and other databases. Since the compounds are indirectly correlated with diseases and their symptoms, a compound can be estimated for its pharmaceutical action, adapted disease, side effects and the like evaluating such information.

The network of compounds and proteins may be constituted by using information on interactions obtained from the existing interaction databases as well as technical documents in the field of medicine and biology by automatic extraction. The network constitution by automatic extraction from documents has the merit that it enables incorporation of the most current information with less leakage compared to manual updating. This enables detailed representation between elements.

Next, features such as the functions of the proteins and genes are extracted from the gene database, protein database, disease database, and other databases that are open to the public. The information extracted are those on relevant diseases, functions, toxicities, and the like, and the information is correlated with the genes and the proteins in the network. Such addition of the gene/protein information to the network enables indirect correlation of the compound with the diseases and the like.

By constituting the network, the compound which is the candidate for a new drug is correlated with a protein by the compound-protein network. This correlation extends not only to the protein in the network that undergoes direct interaction with the compound but also to the relation with further proteins. This enables correlation of the compound to the gene-protein interaction which has not been experimentally confirmed, hence, prediction of pharmaceutical effects, side effects, and relevant diseases of the compound which had not been possible by conventional art.

The evaluation of the functions is not simple sum of the information on the correlated protein, but evaluation of the information on the compound by weighting minimum path length to each protein, significance of the protein, cross referencing of the protein, and the like.

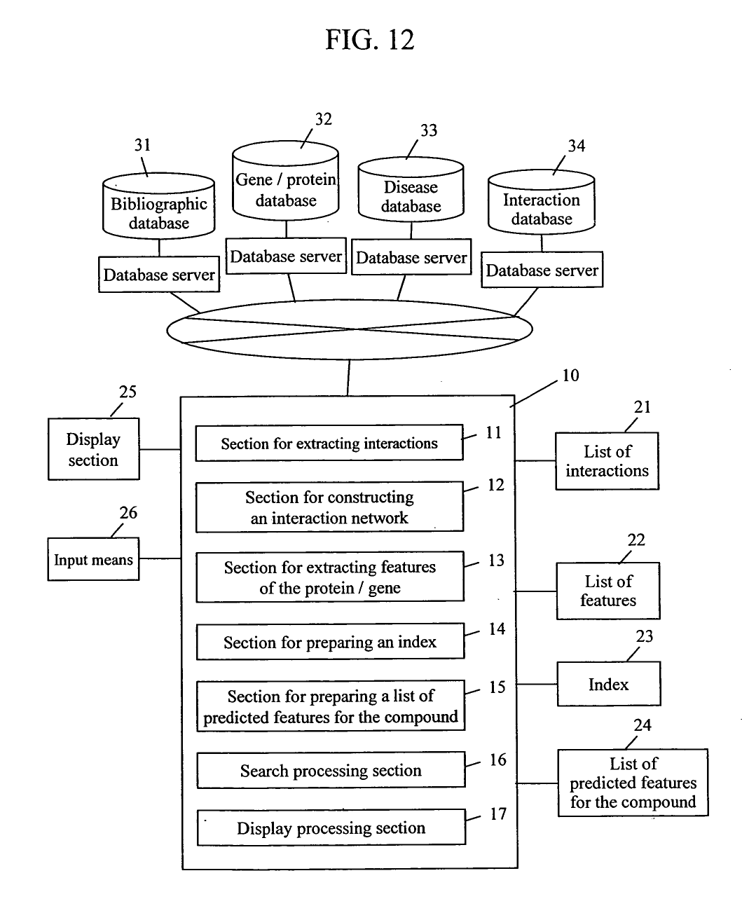

FIG. 12 is a schematic view illustrating an embodiment of the system for predicting functions of a compound according to the present invention. A search server 10 comprises a section for extracting interactions 11; a section for constructing interaction network 12; a section for extracting features of protein/gene 13; a section for preparing index 14; a section for preparing list of predicted features for the compound 15; a search processing section 16; and a display processing section 17. The search server 10 also comprises a list of interactions 21 having accumulated information on the interactions between compound, gene, and protein or the interactions between gene/protein; a list of features 22 comprising a list disease names and pharmaceutical actions and other functions relevant to the compound, wherein each item is indexed; an index 23 prepared by the section for preparing index 14; and a list of predicted features for the compound 24 prepared by the section for preparing list of predicted features for the compound 15; and also, an input means 26 for entry of the search conditions; and a display section 25 for displaying an input screen or search results. The search server 10 can make an access to a bibliographic database 31 having accumulation of documents in the field of medicine, biology, and the like, a gene/protein database 32 accommodating the information of genes and proteins, a disease database 33 having accumulated information on diseases, interaction database 34, and the like through internet or other communication network to acquire necessary information from such database.

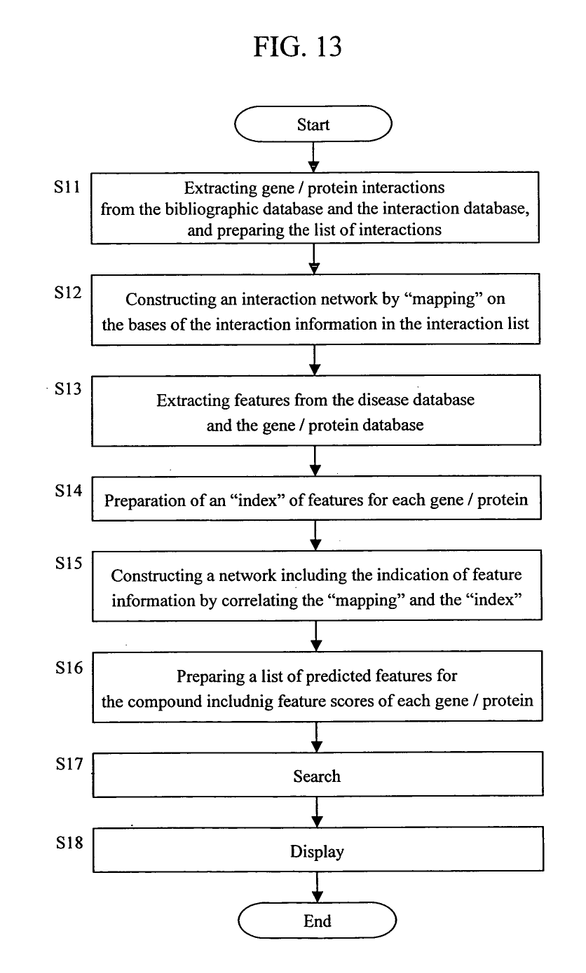

FIG. 13 is a view illustrating the flow of the process using the system for predicting functions of a compound according to the present invention. In the present invention, interaction network is first constructed by “mapping” by extracting gene/protein interactions from the bibliographic database 31 and the interaction database 34 to thereby build an “interaction list” (S11). The interaction network is then built by “mapping” based on the information on the interactions obtained from the “interaction list” (S12). Next, features are extracted from the disease database 33 and the gene/protein database 32 (S13), and an “index” of features relating to the genes and the proteins is prepared from the thus extracted information (S14). A network with the indication of feature information is built by correlating the “mapping” and the “index” (S15), and the list of predicted features for the compound which describes feature scores for each gene/protein that constitute the feature information on the compound is prepared (S16). In the searching of step 17 and displaying of the step 18, a graphic interface on the display section 25 is used to show, upon request from the user, relevant genes/proteins with highlighting, list of relevant compounds for the particular disease, and predictive value for each feature in descending order.

It is to be noted that the order of the construction of the interaction network by the steps 11 to 12 and the preparation of the index by the steps 13 and 14 is not limited, and the preparation of the index by the steps 13 and 14 may be carried out before the construction of the interaction network by the steps 11 to 12. Alternatively, the construction of the interaction network by the steps 11 to 12 and the preparation of the index by the steps 13 and 14 may be conducted simultaneously.

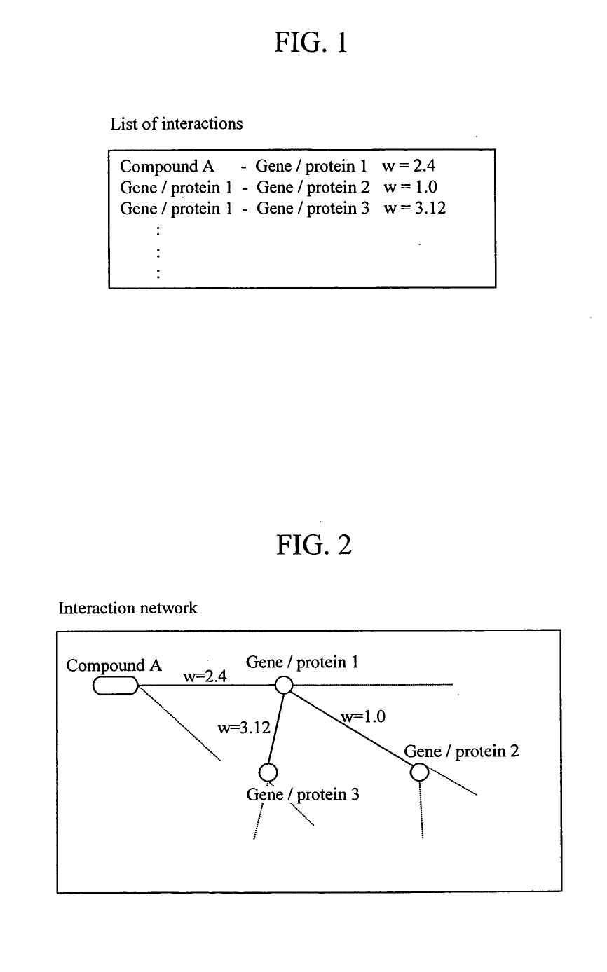

Next, the present invention is described in further detail by describing each step of the process shown in FIG. 13. First, the interaction list 21 including the information on the interaction between the gene and/or protein and the compound is prepared in step 11. The section for extracting interactions 11 of the search server 10 integrates the information on interactions extracted from the medical documents in the bibliographic database 31 and the information on gene/protein interaction extracted from the interaction database 34 open to the public to prepare the interaction list 21. FIG. 1 shows an example of the thus prepared interaction list 21, and the interaction list 21 has listed therein pairs of the gene/protein and the compound that undergo interaction. Each interaction information includes, in addition to the information of the interacting two substances, interaction significance w in term of numerical value determined by considering the significance of the interaction. The interaction significance w used is, for example, correlation value of each interaction included in the interaction database from which interaction information is acquired.

Next, in step 12, the section for constructing interaction network 12 conducts mapping of the genes/proteins and the compounds into the network by referring to the interaction list 21. In the interaction list 21, one interaction is represented as a relation between two of the gene, the protein, and the compound. As shown in FIG. 2, the network is mapped by using nodes of the genes/proteins or the compounds and the edges of the relations, and by this mapping, the compound is directly or indirectly correlated with a group of genes/proteins.

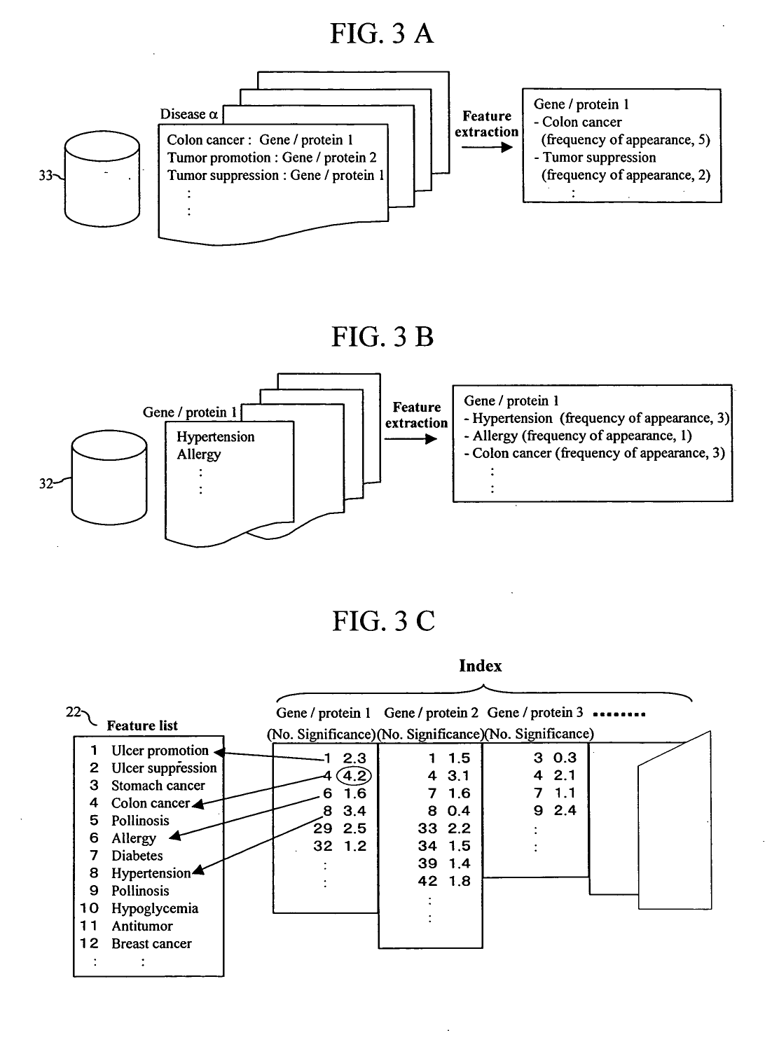

In step 13, the part describing the gene/protein and features such as disease is extracted from a database open to the public such as disease database 33 as shown in FIG. 3A. The part describing the gene/protein and associated features such as diseases is extracted also from the gene/protein database 32 as show in FIG. 3B. The frequency of the appearance of such correlation in the database is also counted.

In step 14, such relations are described as a list of references to the feature list 22 for each gene/protein, and the list is included as an index. The index for each gene/protein i include index number j of the feature list 22, and also, significance fᵢⱼ in numerical value of the feature of the substance given by the frequency of the appearance and the like in the database. The items corresponding to each index in the feature list 22 may be preliminarily set, or alternatively, automatically increased by adding the newly extracted item in the step 13. The significance is defined, for example, by the following equation:
Significance={(Frequency of appearance in the disease database+Frequency of appearance in the gene/protein database)/Total frequency of appearance for all features}}×100

If description of colon cancer appeared in relation to the Gene/protein 1 five times in the disease database, and three times in the gene/protein database as shown in FIGS. 3A to 3C, and if the total frequency of appearance of the Gene/protein 1 in all features of the feature list is 190, the significance f₁₄, namely, the significance of the feature index No. 4 for the Gene/protein 1 is {(5+3)/190}×100=4.2.

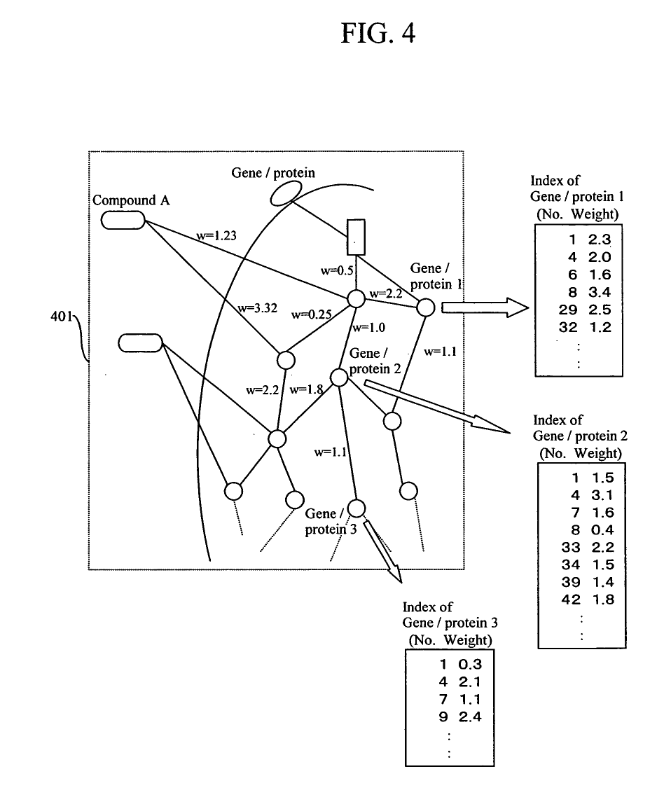

In step 15, the network including the information on the features is built by correlating the mapping and the index. More specifically, the index of each gene/protein is correlated to each of the genes/proteins on the network 401 built by mapping of the compounds and the genes/proteins as shown in FIG. 4. The interaction significance wᵢⱼ is also correlated to the interaction edge represented by the line connecting the substance i and the substance j.

Since the compound is directly or indirectly related to the genes/proteins mapped in the network, the list S of predicted features can be calculated by calculating the sum by referring to the index of the relevant gene/protein in step 16. This correlation is automatically updated when the interaction list 21 is updated simultaneously with the preparation of the index, and the network functions as a dynamic network. As a consequence, the list of predicted features for the compound 24 is updated with the update of the interaction list 21 to thereby enable prediction of the function of the compound based on the latest interaction information.

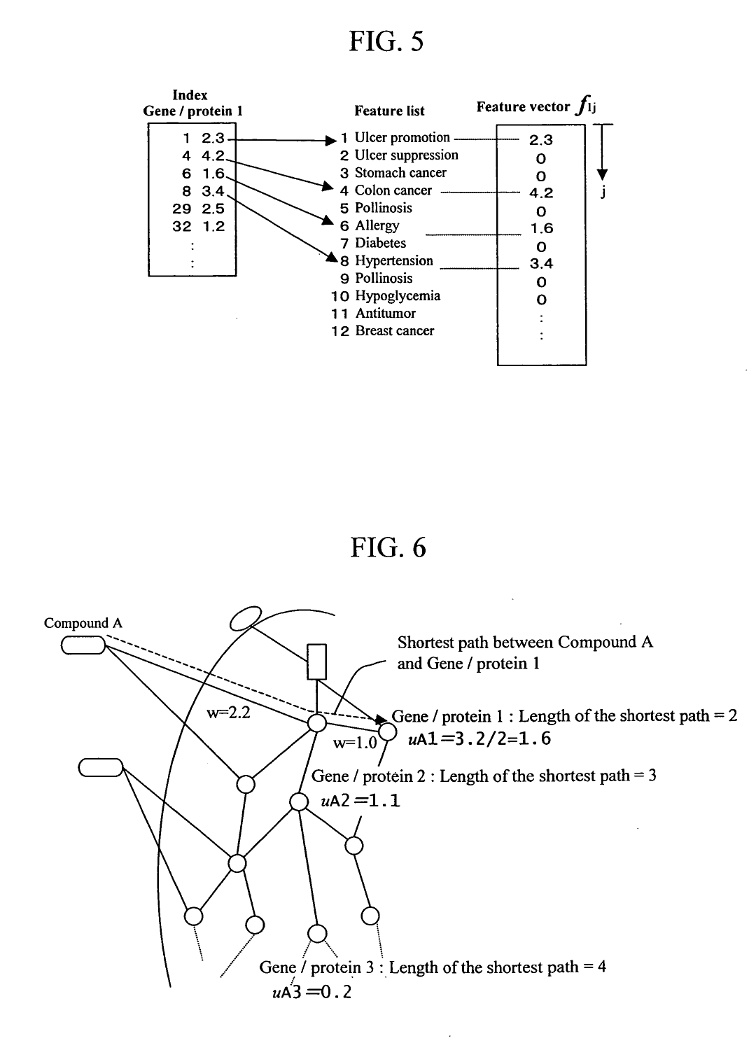

Calculation in the list of predicted features for the compound is carried out as described below. First, the index of each gene/protein is converted to the feature vector as shown in FIG. 5. Significance f of the substance which is the element of the feature vector corresponds to the feature list, and value of the significance is adopted for the value in the list when the gene/protein is related to the feature, and the value is deemed 0 in other cases.

Next, gene/protein weight uAi for each gene/protein i upon selection of Compound A is calculated on the bases of the distance from the Compound A to the gene/protein i as shown in FIG. 6. Since a plurality of routes may be present on the network, the distance of the shortest path of the paths is used for the distance from the Compound A to the gene/protein i. The gene/protein weight uAᵢ is the function of the sum of the interaction significance w on the path and the minimum path length. When two or more minimum paths are present, the gene/protein weight which is the maximum is employed. The gene/protein weight uAᵢ when the reciprocal of the minimum path length is used for the weight calculation is represented by the following equation:
uAi=V(TAi,d(A,i))=TAi/d(A,i)
d(A,i): minimum path length from compound A to protein i,
TAi=sum of the significance of the interactions along the path of the minimum path length, and
V: function of weight value calculated from T and d.

The path length is calculated “1” when nodes are connected by one edge, and “2” when the path is intervened with another node. In the case shown in FIG. 6, the gene/protein weight uA1 of the Gene/protein 1 for the Compound A is calculated by the equation: uA1=3.2/2=−1.6 since the minimum path length between the Compound A and the Gene/protein 1 is “2” and the sum of the interaction significance on the path is calculated as 2.2+1.0=3.3.

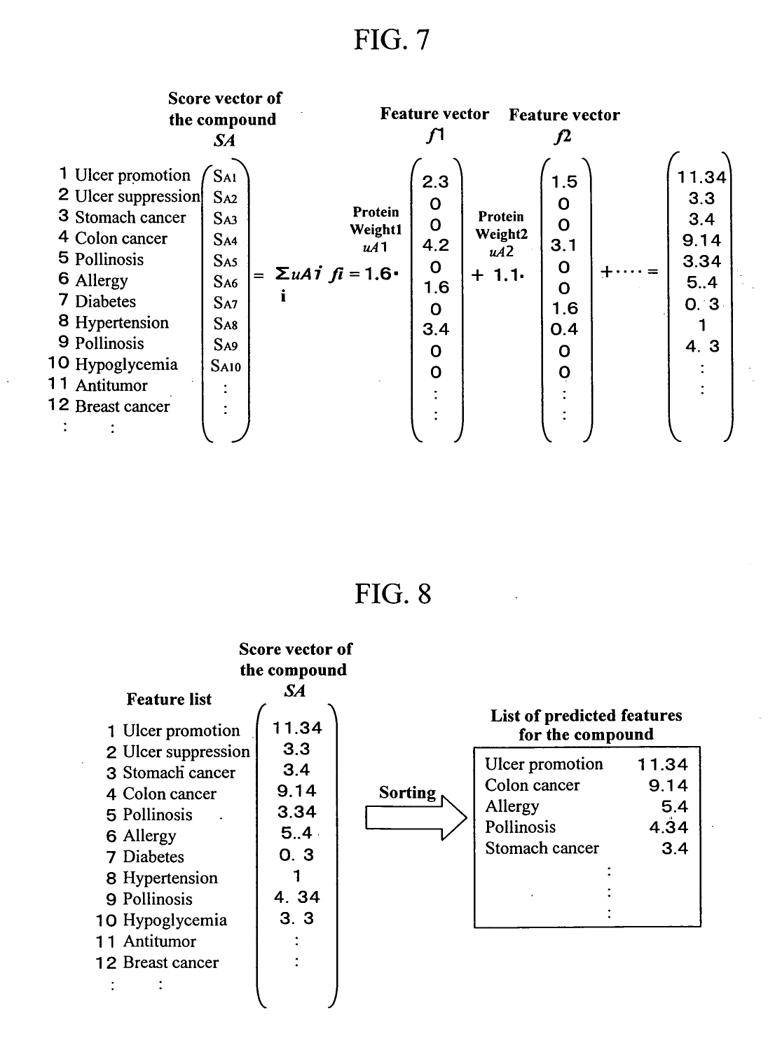

Next, score vector SAj of the compound is calculated as shown in FIG. 7. The score vector SAj is the result of scoring for the j th feature index of the Compound A, which is calculated as the total sum of the product of the feature vector fi of the gene/protein i which is relevant on the network to the compound A and the gene/protein weight uAi.

Finally, the list of predicted features for the compound 24 is obtained as shown in FIG. 8. This is a sorted list of features predicted for the particular compound shown with the SA value. The list of predicted features for the compound 24 can be prepared by sorting the compound score vector SA while correlating it with the feature list.

After the preparation as described above, desired search conditions are entered in the step 17 through the input means 26 by the aid of the visual interface displayed on the display section 25 and the results are shown in the step 18 on the display section 25. Embodiments of the search and the display are described in the following section.

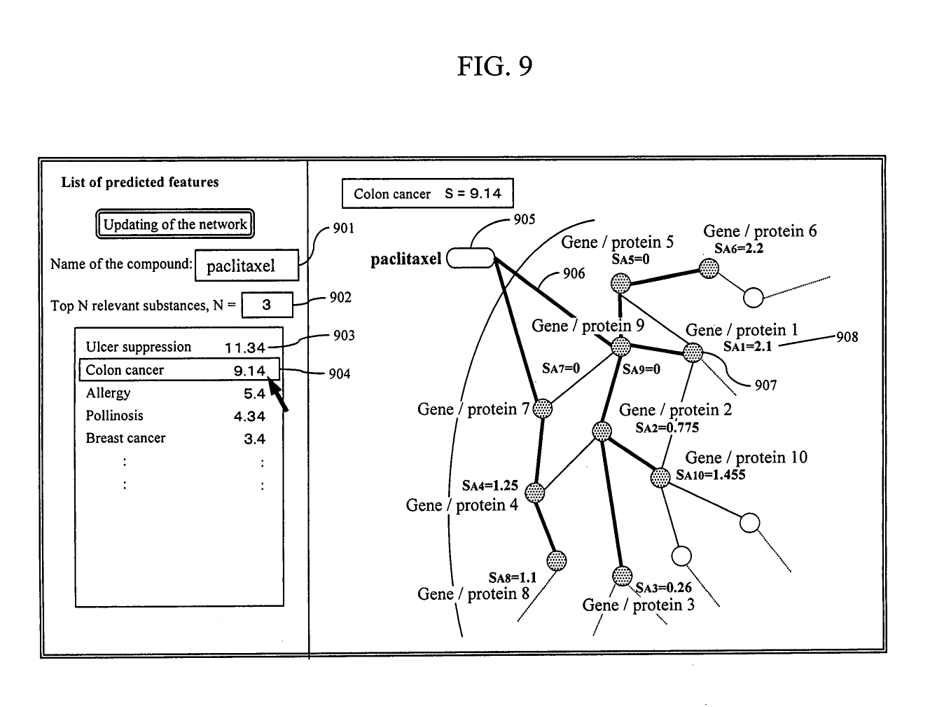

(1) Highlighted Indication of Relevant Gene/Protein (FIG. 9)

When the item of interest is clicked on the list of predicted features for the compound shown on the interface, the relevant genes/proteins can be highlighted on the network diagram.

First, the name of the compound to be searched is entered in text box 901, and in response, the search processing section 16 searches the part including the entered compound in the interaction network, and simultaneously, the list of predicted features for the entered compound is searched in the list of predicted features for the compound 24. The search result is then handed to the display processing section 17. The display processing section 17 processes the handed data, and the display section 15 displays the gene/protein network diagram relating to the entered compound and the predicted feature and the list of predicted features 903 which shows the score of the feature. When feature item 904 is selected in this list by the manipulation of the input means 26, the gene/protein node 907 which is relevant and responsible for the feature is highlighted, and simultaneously, the path 906 from the compound 905 to the relevant substance 907 is highlighted in the network diagram on the right hand side. The contribution value 908 which takes the weight into consideration is simultaneously displayed with the gene/protein node. The number of relevant gene/proteins highlighted is the number entered in the input panel 902, and the N genes/proteins displayed are those having the largest contribution value to the Nth value. In the case shown in the drawings, the calculation of the significance of colon cancer for the paclitaxel is as described below.

$$\begin{matrix}{S}_{A} ( colon cancer ) = \sum {S}_{Ai} \\ = 2.1 + 0.775 - 0.26 + 1.25 + 0 + 2.2 + 0 + 1 .1 + 0 + 1.445 \\ = 9.14\end{matrix}$$

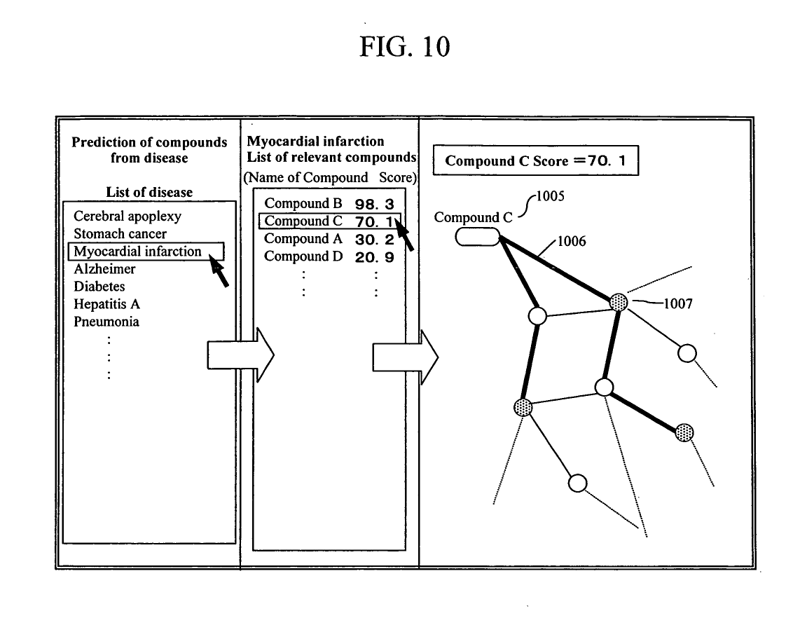

(2) Displaying of the List of Relevant Compounds from the Disease (FIG. 10)

In the present invention, predicted score of the disease can be calculated from the compound, and this in turn means that, the score of the relevant compound can be calculated from the disease by using the same information. When a particular disease is selected, this function enables displaying of the list of the compounds strongly related to the disease in the descending order. When this function is used, screening of compounds can be conducted by using this list in the drug discovery for a particular disease, and this enables drastic reduction in the number of steps involved in the experiments.

First, the disease to be displayed is selected from the disease list. In the case of FIG. 10, the operator has selected myocardial infarction. In the search processing section 16, the score of the selected disease (myocardial infarction in the case shown in the drawings) is searched in each compound of the list of predicted features for the compound 24, and the item is sorted in the descending order of the score, and handed to the display processing section 17. The display processing section 17 displays in the display section 25 the compound which has effects on the selected disease together with the degree of such effect in the form of a list of relevant compounds. When one compound is further selected from the list of the relevant compounds, the path between the compound and the relevant gene/protein related to the selected disease is highlighted in the network diagram on the right hand side. The information on the gene/protein network related to the selected compound is searched by the search processing section 16, and the search result is handed to the display processing section for display in the display section 25.

When this function is used, efficient search of the compound having strong relation to the disease is enabled from several hundred candidate compounds, and the search can be effected from those having the strongest relation with the disease. Significant reduction of the steps in the subsequent verification experiments is thereby enabled.

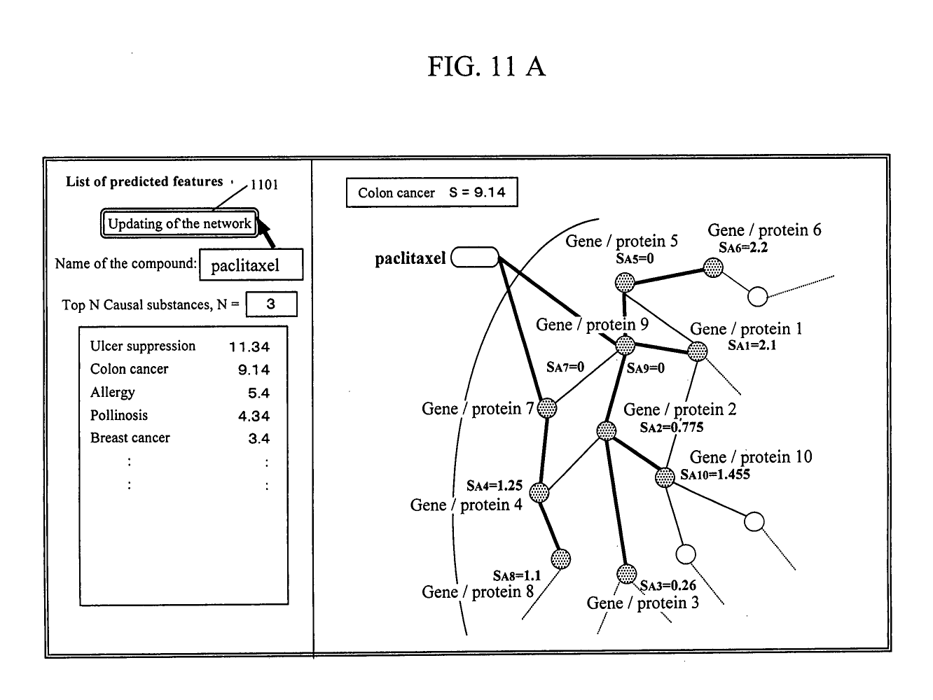

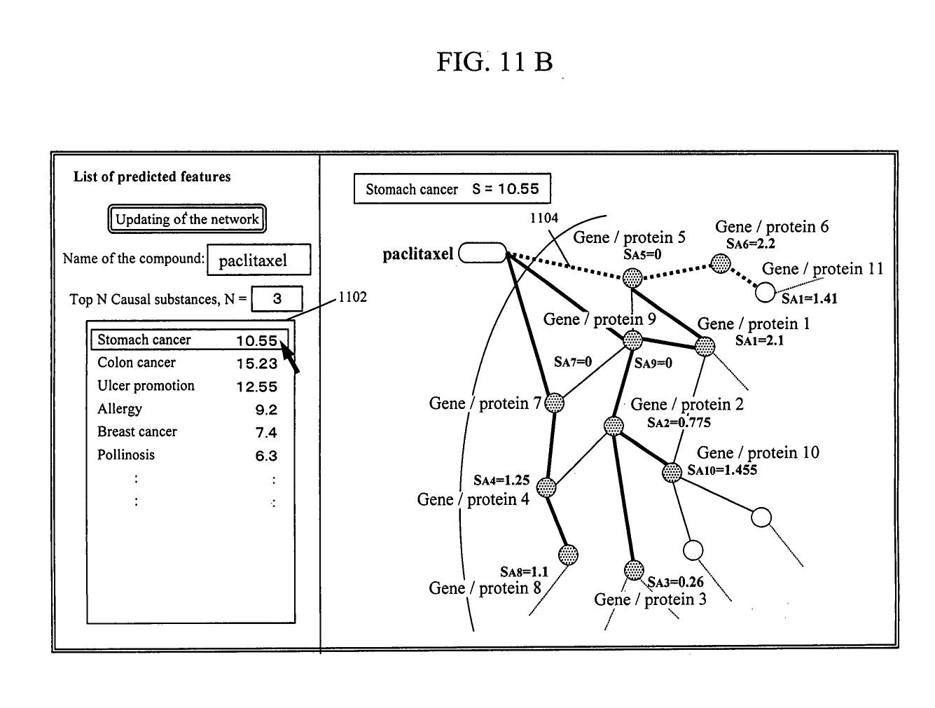

(3) Indication of Predictive Value for Each Feature in Descending Order (FIGS. 11A and 11B)

The interaction list 21 including the interaction data used in constituting the interaction network is always updated to its latest state with the updating of the bibliographic database 31 and the updating of the interaction database 34, and this enables reflection of the interaction list 21 of the latest state to the network, with the latest feature value data. The user can then visually observe the new findings such as properties of the target compound which were unknown in the past, and use of this function enables prediction of new functions, for example, for the drugs which are already in practical use.

As shown in FIG. 11A, when network updating button 1101 is clicked in the screen showing the compound and the search result for its feature, the section for constructing interaction the network 12 automatically updates the network by referring to the interaction list 21, and simultaneously, the predictive value for the feature is recalculated. As a consequence, the list of the predicted values is updated as shown in FIG. 11B with the change in the ranking. When the feature item (stomach cancer in the case of the drawing) is selected from the updated list or predicted values 1102, the network diagram is also updated with the path 1104 to the new relevant substance highlighted.

What is claimed is:

1. A method for predicting function of a compound comprising the steps of
acquiring information on an interacting pairs of compound and gene/protein, and information on significance of such interaction by extracting information on the interaction between said gene, said protein, and said compound from a database based on input of search order;
building an interaction network from the information on the interaction, said network comprising nodes of the compounds, genes, and proteins, and edges of interaction relations;
extracting information on the features of the gene or the protein from the database;
integrating the extracted feature information to constitute a feature list wherein a plurality of features are listed, and preparing an index for items of the feature list wherein significance for each gene or protein wherein the significance of each item is listed;
determining a predictive value for each item of said feature list for each compound by using the distance between the compound and the node in said network, the information on the significance of the interaction borne by the edge, and the index corresponding to the node, and
presenting the thus determined predictive value as an output.

2. The method for predicting function of a compound according claim 1 wherein, when the name of the compound is entered with the input of the search order, display section displays items of the feature list corresponding to the compound with the predictive value in the descending order of the predictive value, and the interaction network relevant with the entered compound.

3. The method for predicting function of a compound according claim 2 wherein, when a feature item displayed is selected, nodes and paths to such nodes relating to the selected feature are highlighted.

4. The method for predicting function of a compound according claim 1 wherein, when an item in the feature list is entered, the display section displays names of the compounds in the descending order of the predictive value by comparing the data in the feature lists and sorting the features according to the predictive value.

5. The method for predicting function of a compound according claim 4 wherein, when one of the compound names displayed is selected, the display section displays the interaction network relating to the selected compound.

6. The method for predicting function of a compound according claim 1 wherein said feature includes name of the disease.

7. A system for predicting function of a compound comprising
an input means for entering the subject to be searched;
a list of interactions including information on pairs of gene/protein and compound that are involved in the interaction and significance of the interaction;
a list of features including a plurality of items relating to each disease;
a section for building an interaction network on the bases of the information of the interaction list, the interaction network comprising nodes of the compounds, the genes, and the proteins and edges of the interactions;
an index including information on significance of each item in said feature list for each of said gene or protein;
a section for preparing a list of features predicted for the compound by determining a predictive value for each item of said feature list for each compound by using the distance between the compound and the node in said network, the information on the significance of the interaction borne by the edge, and the index corresponding to the node;
a list of features predicted for the compound prepared by said section for preparing the list of features predicted for the compound;
a section for search and processing which performs the search of items having a high predictive value from said list of features predicted for the compound for the search subject entered by said input means; and
a display section for displaying the search result.

8. The system for predicting function of a compound according claim 7 wherein, when the name of the compound is entered, the display section displays items of the feature list corresponding to the compound with the predictive value in the descending order of the predictive value, and the interaction network relevant with the entered compound.

9. The system for predicting function of a compound according claim 8 wherein, when a feature item displayed is selected, nodes and paths to such nodes relating to the selected feature are highlighted.

10. The system for predicting function of a compound according claim 7 wherein, when an item in the feature list is entered in said input means, the display section displays names of the compounds in the descending order of the predictive value.

11. The systein for predicting function of a compound according claim 10 wherein, when one of the compound names displayed is selected, the display section displays the interaction network relating to the selected compound.

12. The system for predicting function of a compound according claim 7 wherein the system further comprises
a section for extracting interaction wherein information on an interacting pairs of compound and gene/protein, and information on significance of such interaction are acquired by extracting information on the interaction between said gene, said protein, and said compound from a database.

13. The system for predicting function of a compound according claim 7 wherein the system further comprises
a section for extracting features of the protein and the gene wherein features of the gene or the protein is extracted from the database; and
a section for preparing an index wherein said index is prepared by integrating the feature information extracted by said section for extracting the features of the protein and the gene.
